(19) United States
(12) Patent Application Publication
(10) Pub. No.: US 2016/0168776 A1
(43) Pub. Date: Jun. 16, 2016

(54) WASHING CONTROL METHOD FOR CIRCULATIVE WATER PURIFICATION OF WASHING MACHINE AND WASHING MACHINE THEREOF

(71) Applicants: HAIER GROUP CORPORATION, Qingdao, Shandong (CN); HEFEI HAIER WASHING MACHINE CO., LTD., Anhui (CN)

(72) Inventors: Sheng XU, Qingdao, Shandong (CN); Zhenxing HUANG, Qingdao, Shandong (CN); Yuling CHEN, Qingdao, Shandong (CN)

(21) Appl. No.: 14/906,181

(22) PCT Filed: Dec. 18, 2013
(86) PCT No.: PCT/CN2013/089813

§ 371 Date: Jan. 19, 2016

(30) Foreign Application Priority Data
Jul. 19, 2013 (CN) 201310305616.5

(51) Int. Cl. D06F 39/00; D06F 39/10; C02F 1/00

(52) U.S. Cl. CPC D06F 39/004; C02F 1/008; D06F 39/10; C02F 2307/12; C02F 2209/11; C02F 2103/002

(57) ABSTRACT

A control method for circulation water purification of a washing machine and a washing machine thereof. The washing machine includes a water supply system, a drainage system, a circulation water purification apparatus and a turbidity detection apparatus. The circulation water purification apparatus is configured to perform circulation water purification and rinsing during a rinsing process. The method includes detecting, by the turbidity detection apparatus, turbidity of washing water, draining an amount of the washing water predetermined according the corresponding detected turbidity, supplying clean water to reduce the turbidity, and performing the circulation water purification and rinsing.

### FIELD OF THE INVENTION

The present invention relates generally to washing machines, and more particularly, to a washing machine with purified-water circulation and rinsing functions and a washing control method for circulative water purification of the washing machine.

### BACKGROUND OF THE INVENTION

With the development of the living standard of people, a washing machine has already become one of major home appliances in daily life. A washing process of the washing machine mainly includes washing, and drying stages. In the washing stage, water is supplied to the washing machine and clothes are washed by using a detergent. At the rinsing stage, more water needs to be supplied or the clothes need to be rinsed multiple rinsing times to rinse a stain or residue of the detergent out, which definitely consumes a large amount of water. Even for a water-saving drum washing machine, at least two times of rinsing needs to be performed to clean clothes by means of rinsing, and in this process, running water of at least more than 30 L needs to be consumed. Sometimes, there are fewer stains on clothes or fewer detergents are put in, and the clothes may be cleaned by twice rinsing, but a user selects three times of rinsing. Therefore, a water resource is definitely wasted. For example, for an automatic washing machine of 6 Kg, generally, water of about 100 L is used for twice rinsing. How to save water and electricity during clothes washing is always a focus of consumers.

So far there is no water purification and recycling apparatus that is used together with a household washing machine. Even for a washing machine with a water saving function, generally, a storage tank is installed at a side of the washing machine, and a water pump is used to supply water and drain water, where once water supply can support three times of rinsing, thereby achieving the water saving function. However, water after washing cannot be stored, and the washing machine is caused to have a complex and large structure, which is not beneficial to transportation, recycling processing, and the like. Due to size, structure and flexibility limitations, an original function of the washing machine is affected and a function of a water saving tank cannot be fully used. Based on a conventional washing manner, to better save water resources, many manufacturers invest in a large amount of research and development.

For recycling of washing water, Chinese Patent Application No. 200810072420.5, entitled “recycling water saving apparatus for washing machine” discloses that washing water is input into a water drum for purification processing. In the disclosure, the washing water of the first time is not purified and is directly drained, and rinsing water of the second and third times is purified and needs to be kept, so as to be used for next washing.

In the foregoing technology, a “water recycling technology” is to use the purified rinsing water. However, the technology cannot recycle the washing water (initial washing water) of the first time, and the purified water also needs to be kept, so as to be used for next washing, and cannot be used during the current washing.

Therefore, a heretofore unaddressed need exists in the art to address the aforementioned deficiencies and inadequacies.

### SUMMARY OF THE INVENTION

One of the objectives of the present invention is to provide a water-saving and time-saving control method for circulative water purification of a washing machine, so as to overcome defects in the prior art.

Another objective of the present invention is to provide the water-saving and time-saving washing machine.

In one aspect of the present invention, a washing control method for circulative water purification of a washing machine is provided, where the washing machine includes a water supply system, a drainage system, a circulation water purification apparatus, and a turbidity detection apparatus, and the circulation water purification apparatus executes circulation water purification and rinsing during a rinsing process. In one embodiment, the method includes detecting, by the turbidity detection apparatus, turbidity of washing water, draining an amount of the washing water predetermined according the corresponding detected turbidity, supplying clean water to reduce the turbidity, and performing the circulation water purification and rinsing.

In one embodiment, the washing machine is provided with different turbidity ranges of the washing water. The method further includes determining a corresponding turbidity range according to the detected turbidity of the washing water, and setting different proportions of an amount of the washing water to be drained to a total amount of the washing water according to the different turbidity ranges.

In one embodiment, after the amount of the washing water predetermined according the detected turbidity is drained, the step of supplying the clean water to reduce the turbidity comprises supplying the clean water until a set rinsing water level is reached.

In one embodiment, after washing is completed, the turbidity detection apparatus detects the washing water turbidity. If the turbidity is less than a preset first turbidity threshold, the circulation water purification apparatus is directly turned on to perform circulation water purification. If the turbidity is greater than a preset second turbidity threshold, the washing water is completely drained, clean water is resupplied for rinsing, and at the same time, the circulation water purification is preformed. If the turbidity is within an interval of the preset first turbidity threshold and the preset second turbidity threshold, the amount of the washing water predetermined according the detected turbidity is drained, the remaining washing water is reserved, the clean water is supplied to reduce the turbidity, and the circulation water purification and rinsing is preformed

In one embodiment, an alternative solution is: after washing is completed, the turbidity detection apparatus detects the washing water turbidity. If the turbidity is less than a preset first turbidity threshold, the circulation water purification apparatus is directly turned on to perform circulation water purification. If the turbidity is greater than the preset first turbidity threshold, the amount of the washing water predetermined according the detected turbidity is drained, the clean water is supplied, and then the circulation water purification and rinsing is preformed

In one embodiment, during a circulation water purification and rinsing process, turbidity of rinsing water is detected at a preset time interval, and if the rinsing water turbidity is less than a set third turbidity threshold, the rinsing is completed, the rinsing process stops, and the circulation water purification apparatus is turned off.

In one embodiment, an alternative solution is: during a circulation water purification and rinsing process, if a working time of the circulation water purification apparatus reaches a preset working time, the rinsing is completed, the rinsing process stops, and the circulation water purification apparatus is turned off.

In one embodiment, the preset working time, for determining ending of the rinsing, of the circulation water purification apparatus is related to a selected washing procedure, and different washing procedures correspond to different preset working times.

The turbidity is reduced by means of the drainage and water supply, so that the circulation water purification apparatus achieves water purification more easily, and relatively reduces a time that is used for circulation water supply for rinsing. However, for some clothing materials, for example, clothes such as cotton or large clothes that have strong water absorption, turbid water that is absorbed in the clothes is still released after a long time the clean water is supplied for rinsing. Therefore, it may cause that the cloths are rinsed uncleanly within the set time or a rinsing time is excessively long. To avoid the case, further, during a circulation water purification and rinsing process, if the rinsing reaches a preset time, it is detected whether rinsing water turbidity continuously increases within a preset time range, and if yes, after water is completely or partially drained according to a change rate of the turbidity, clean water is supplied for rinsing; or if not, the circulation water purification and rinsing continues until the rinsing ends. Further, the foregoing preset time is related to a quantity of clothes and the rinsing water level.

In one embodiment, the method includes setting proportions of an amount of the washing water to be drained to a total amount of the washing water according to the corresponding turbidities, wherein proportional values is greater than 0 and is less than 1, there is at least one proportional value, where a value of the proportional values and a quantity of the proportional values are related to a washing procedure. For example, for clothes such as cotton or large clothes, three proportional values are set according to turbidity of three different ranges, for example, if the turbidity is (600, 700] NTU, water with ⅓ of the amount of the washing water is drained; if the turbidity is (700, 800] NTU, water with ½ of the amount of the washing water is drained; and if the turbidity is (800, 900) NTU, water with ⅔ of the amount of the washing water is drained. For a relatively small quantity of cloths or polyester cloths, only one proportional value needs to be set, for example, if the corresponding turbidity is 700 NTU to 800 NTU, water with ½ of the amount of washing water is drained. The foregoing value is not fixed, and is only one of manners.

In another aspect of the present invention, the washing machine includes a water containing drum, and a circulation water purification passage and a backwash passage. The circulation water purification passage comprises the water containing drum, a drainage system, a circulation water purification apparatus, a water supply system and a circulation passage of the water containing drum in order. The backwash passage comprises a water supply system, a circulation water purification apparatus, and a drainage system passage.

In one embodiment, the circulation water purification apparatus includes a circulation water purifier. The circulation water purifier includes a filtering and purification module such as active carbon or an R0 film, and can purify circulation water flowing through the circulation water purification apparatus; the backwash passage can wash off a stain that is filtered and purified in the circulation water purification apparatus.

By means of the foregoing technical solutions, compared with the prior art, the present invention has the following beneficial effects:

According to the washing machine described in the present invention, after washing ends, a turbidity detection apparatus automatically detects washing water turbidity, and determines, based on this, whether washing water is drained and how much a drainage proportion is. Then, enough running water is added, so that the washing water turbidity is reduced to a range suitable for purification, and a circulation water purification apparatus is started for rinsing, so that a maximum water resource is saved while purification efficiency is not affected, and a solution in which clean water is supplied after some water is drained, so as to reduce turbidity is more time-saving than a solution, with a higher turbidity purification degree, in which entire washing water is drained. Therefore, objectives of ending once cleaned and saving water and time are achieved.

### BRIEF DESCRIPTION OF THE DRAWINGS

FIG. 1 is a schematic structural diagram of a washing machine according to one embodiment of the present invention; wherein numeral 1 is referred to a tank; 2 is referred to an outer drum; 3 is referred to a inner drum; 4 is referred to a water supply system; 41 is referred to a first water supply valve; 42 is referred to a second water supply valve; 43 is referred to a third water supply valve; 44 is referred to a first water supply pipe; 45 is referred to a second water supply pipe; 46 is referred to a third water supply pipe; 47 is referred to a detergent box; 48 is referred to a fourth water supply pipe; 5 is referred to a computer board controller; 6 is referred to a door cover; 7 is referred to a drainage system; 71 is referred to a drainage hose; 72 is referred to a drainage pump; 73 is referred to a first drainpipe; 74 is referred to a second drainpipe; 8 is referred to a circulation water purification apparatus; 81 is referred to a circulation water purifier; 82 is referred to a fixing apparatus; 83 is referred to a three-way pipe; 84 is referred to a first electric three-way ball valve; 85 is referred to a backwash drainage valve; 86 is referred to a first circulation pipe; 87 is referred to a second electric three-way ball valve; 88 is referred to a second circulation pipe; 89 is referred to a nozzle; 9 is referred to a motor driving apparatus; 10 is referred to a turbidity detection apparatus; and 11 is referred to a water level detection apparatus.

FIG. 2 is a schematic diagram of a washing procedure of the washing machine according to one embodiment of the present invention.

FIG. 3 is a schematic diagram of a circulation water purification and rinsing procedure of the washing machine according to one embodiment of the present invention.

### DETAILED DESCRIPTION OF THE INVENTION

The following description of the exemplary embodiments of the invention is presented only for the purposes of illustration and description and is not intended to be exhaustive or to limit the invention to the precise forms disclosed.

### Embodiment 1

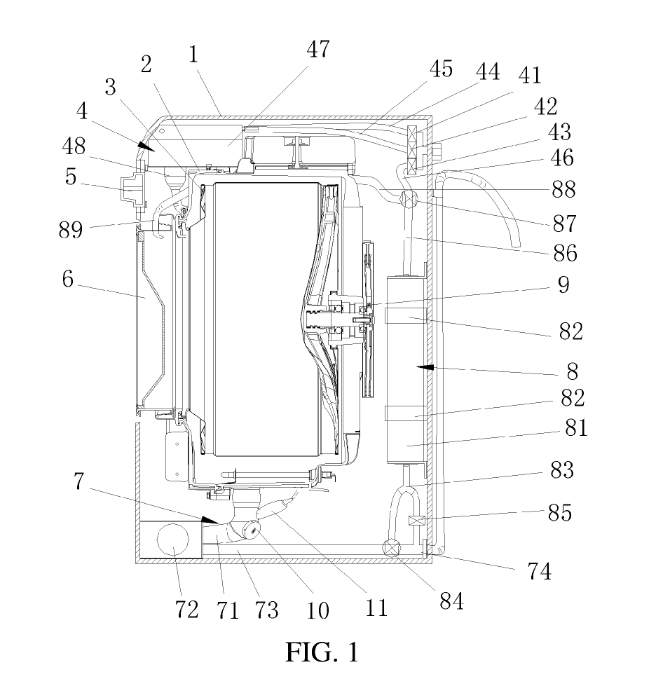

As shown in FIG. 1, a washing machine of the present invention mainly includes: a tank 1, an outer drum 2, an inner drum 3, a water supply system 4, a computer board controller 5, a drainage system 7, a circulation water purification apparatus 8, and a motor driving apparatus 9. The water supply system 4 includes: a first water supply valve 41, a second water supply valve 42, a third water supply valve 43, a first water supply pipe 44, a second water supply pipe 45, a third water supply pipe 46, a detergent box 47, and a fourth water supply pipe 48. The first water supply valve 41 is in communication with the detergent box 47 through the first water supply pipe 44, and the detergent box 47 is in communication with the outer drum 2 through the fourth water supply pipe 48, which is a preliminary water supply passage for washing water. The second water supply valve 42 is in communication with the detergent box 47 through the second water supply pipe 45, and the detergent box 47 is in communication with the outer drum 2 through the fourth water supply pipe 48, which is a main water supply passage for washing water. The third water supply valve 43 is in communication with the second electric three-way ball valve 87 through the third water supply pipe 46, which is a backwash water supply passage of the circulation water purification apparatus 8. The drainage system 4 includes: a drainage hose 71, a drainage pump, a first drainpipe 73, and a second drainpipe 74. A turbidity detection apparatus 10 and a water level detection apparatus 11 are installed on the drainage hose 71, and are separately configured to detect washing water turbidity and a water level within the outer drum. The first drainpipe 73 is in communication with a three-way pipe 83 and the second drainpipe 74 by using a first electric three-way ball valve, and the second drainpipe is in communication with the three-way pipe 83 by using a backwash drainage valve 85. The circulation water purification apparatus 8 includes: a circulation water purifier 81, a fixing apparatus 82, the three-way pipe 83, the first electric three-way ball valve 84, the backwash drainage valve 85, a first circulation pipe 86, the second electric three-way ball valve 87, a second circulation pipe 88, and a nozzle 89. The circulation water purifier 81 is fixed on the tank 1 by using the fixing apparatus 82, where the circulation water purifier includes a filtering and purification module such as active carbon or an R0 film, and can purify circulation water flowing through the water purification apparatus.

The outer drum 2, the drainage hose 71, the drainage pump 72, the first drainpipe 73, the first electric three-way ball valve 84, the three-way pipe 83, the first circulation pipe 86 of the circulation water purifier 81, the second electric three-way ball valve 87, the second circulation pipe 88, and the nozzle 89 sequentially constitutes a circulation water purification passage.

The third water supply valve 43, the third water supply pipe 46, the second electric three-way ball valve 87, the first circulation pipe 86, the circulation water purifier 81, the three-way pipe 83, the backwash drainage valve 85, and the second drainpipe 74 sequentially constitutes a water flow backwash passage, where running water washes off a stain collected by the circulation water purifier, and is drained outside the washing machine, for next circulation purification of washing water.

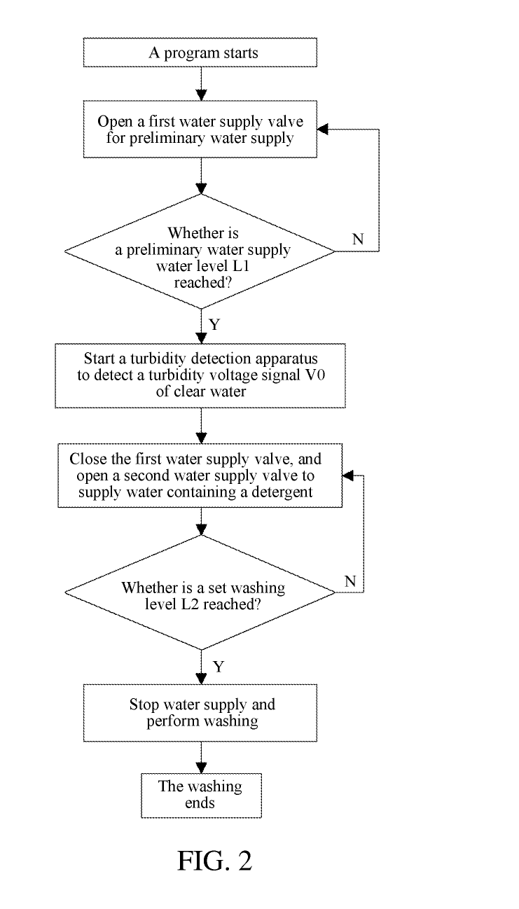

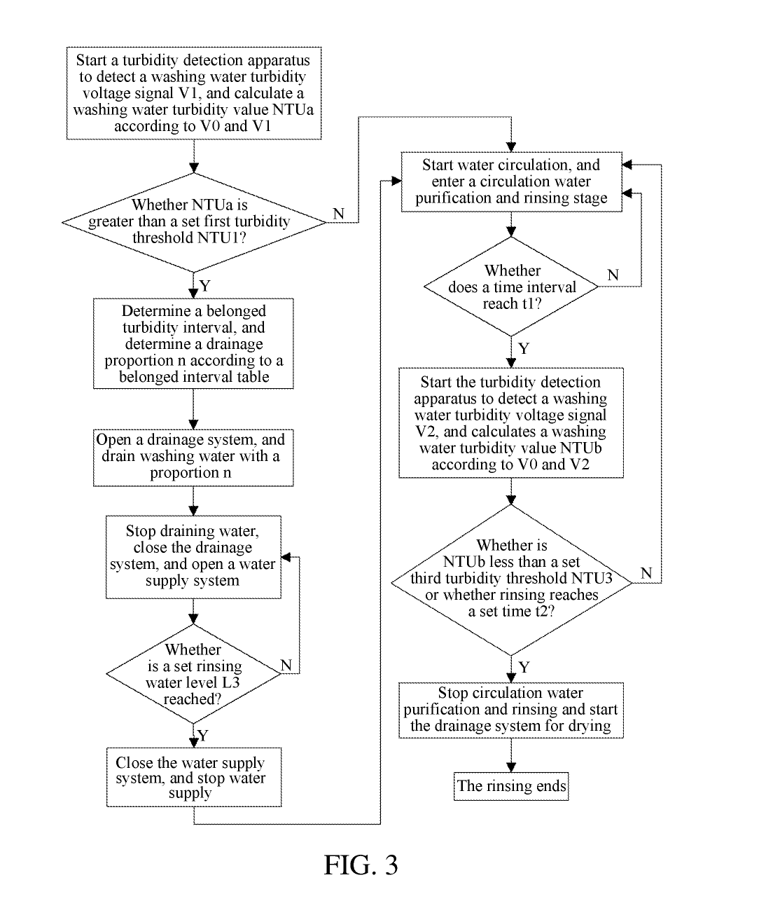

As shown in FIGS. 2 and 3, when clothes are washed, after a user starts a procedure, the computer board controller of the washing machine opens the first water supply valve 41 for preliminary water supply, and clean running water sequentially passes through the first water supply pipe 44, the detergent box 47, and the fourth water supply pipe 48 to enter the outer drum 2, and preferentially fills the drainage hose 71. When the water level detection apparatus 11 detects that supplied water reaches a preliminary water supply water level L1, the turbidity detection apparatus 10 is started to detect a turbidity voltage signal V0 of clean water. Then the first water supply valve 41 is closed, the second water supply valve 42 is opened, and the running water sequentially passes through the second water supply pipe 45, the detergent box 47, and the fourth water supply pipe 48, so that water containing a detergent flows into the outer drum 2. After a washing set water level L2 is reached, the second water supply valve 42 is closed to stop water supply, and a washing stage reaches.

After washing ends, the turbidity detection apparatus is started to detect a washing water turbidity voltage signal V1, and calculates a washing water turbidity value NTUa according to V0, V1 and a turbidity calculation formula. It is determined whether NTUa is greater than a preset first turbidity threshold NTU1 (for example, 600 NTU), and if not, circulation water purification and rinsing is directly performed; or if yes, it indicates that washing water turbidity is excessively high, and it is not suitable for direct circulation purification, so that a belonged turbidity interval needs to be further determined, and a specific proportion of water is determined to be drained according to a belonged interval table, where a correspondence between a proportion n of drained water to total washing water and a turbidity interval is shown in the following table:

| Turbidity interval (NTU) | Drainage proportion n |
|---|---|
| (600, 700] | ⅓ |
| (700, 800] | ½ |
| (800, 900) | ⅔ |
| Above 900 | 1 |

That the washing water turbidity is reduced by means of drainage and water supply is specifically: turning the first electric three-way ball valve 84 to a state in which the first drainpipe 73 is in communication with the second drainpipe 74, and directly turning on the drainage pump 72 to execute a drainage process; after a water level that is obtained after water with a drainage proportion n is drained, turning off the drainage pump 72, and opening the second water supply valve 42 to supply running water; resupplying running water until a set rinsing water level L3 is reached, turning the first electric three-way ball valve 84 to a state in which the first drainpipe 73 is in communication with the three-way pipe 83, and turning the second electric three-way ball valve 87 to a state in which the first circulation pipe 86 is in communication with the second circulation pipe 88; and then starting the drainage pump, and performing circulation purification and rinsing on washing water whose turbidity is reduced. During a circulation purification and rinsing process, a turbidity voltage signal V2 is detected every a t1 time, and a washing water turbidity value NTUb is calculated according to V0, V2, and the turbidity calculation formula. If it is detected that NTUb is less than a set third turbidity threshold NTU3, where NTU3<NTU1, it indicates that the rinsing water turbidity is relatively low, and the clothes is already cleaned by means of rinsing; or if not, the circulation purification and rinsing continues. When NTUb is less than the set third turbidity threshold NTU3 or a total circulation purification time reaches t2, circulation water purification stops, the first electric three-way ball valve 84 is turned to the state in which the first drainpipe 73 is in communication with the second drainpipe 74, and a drainage and drying process is preformed.

After a drying process ends, the drainage pump 72 remains in a working state, and a rotating drum shaking procedure (to make the clothes fluffy and avoid wrinkles) is performed while the second electric three-way ball valve 87 is turned to a state in which the third water supply pipe 46 is in communication with the first circulation pipe 86, and the first electric three-way ball valve 84 is turned to state in which the first drainpipe 73 is in communication with the second drainpipe 74. The backwash drainage valve 85 and the third water supply valve 43 are opened, backwash is performed on the circulation water purifier 81 by using clean running water, and wastewater after washing is drained out from the second drainpipe 74 under the action of pressure of the running water and the drainage pump. When a backwash time reaches t3, the third water supply valve 43 and the backwash drainage valve 85 are closed, and after water is drained for 10 s, the drainage pump 72 is turned off, and the washing ends.

### Embodiment 2

This embodiment differs from Embodiment 1 in that the washing machine is further provided with a second turbidity threshold. After washing ends, the turbidity detection apparatus 10 detects a washing water turbidity voltage signal V1, and calculates a current washing water turbidity value NTUa according to V0, V1 and a turbidity calculation formula. It is determined whether NTUa is less than a preset first turbidity threshold NTU1 (for example, 600 NTU), and if yes, it indicates that washing water turbidity is not high and it is suitable for direct circulation purification; or if not, it is further determined whether NTUa is greater than the preset second turbidity threshold NTU2 (for example, 900 NTU), where NTU1<NTU2. If yes, it indicates that the washing water turbidity is excessively high and it is not suitable for the circulation purification, water is directly drained and clean water is supplied, and circulation water purification and rinsing is performed; or if not, a set turbidity interval that NTUa belongs is determined, and a specific proportion of water is correspondingly drained according to the belonged interval, where a proportion n of drained water to total washing water is n, and 0<n<1. For example, the following table shows a correspondence between a set turbidity threshold interval and the drainage proportion n:

| Turbidity interval (NTU) | Drainage proportion n |
|---|---|
| (600, 700] | ⅓ |
| (700, 800] | ½ |
| (800, 900) | ⅔ |

### Embodiment 3

This embodiment differs from Embodiment 1 in that the washing machine is not provided with a first turbidity threshold, and a set proportion n of drained water to total washing water is n, where 0≦n≦1. A value that is below the first turbidity threshold NTU1 set in Embodiment 1 is set to an interval that corresponds to a corresponding drainage proportion of 0 in this embodiment, and a value that is above a second turbidity threshold NTU2 set in Embodiment 1 is set to an interval that corresponds to a corresponding drainage proportion of 1 in this embodiment. Specifically, a correspondence between a set turbidity interval and a drainage proportion n is:

| Turbidity interval (NTU) | Drainage proportion n |
|---|---|
| Below 600 | 0 |
| (600, 700] | ⅓ |
| (700, 800] | ½ |
| (800, 900) | ⅔ |
| Above 900 | 1 |

Therefore, in this embodiment, after the washing, it needs to only determine, according to the detected washing water turbidity NTUa, the foregoing interval that corresponds to the detected washing water turbidity NTUa, and a next step is performed.

### Embodiment 4

In this embodiment, during a circulation water purification and rinsing process, if the rinsing reaches a preset time, it is detected whether rinsing water turbidity continuously increases within a preset time range, and if yes, after water is completely or partially drained according to a change rate of the turbidity, clean water is supplied for rinsing; or if not, circulation water purification and rinsing continues until the rinsing ends. A proportion of water that is partially drained may be reset, or may be set according to a proportion of washing water to drained water. The foregoing preset time is related to a quantity of clothes and a rinsing water level.

During a washing process in the present invention, during preliminary water supply, a preliminary water supply water level L1 needs to cover the turbidity detection apparatus. The turbidity detection apparatus is generally disposed within the drainage hose 71, and a washing set water level L2 is set by a user according to a quantity of clothes or is determined after the washing machine automatically weights the clothes. A circulation detection time interval t1 is set to a range of 1 min to 3 min, and is preferentially 2 min. A circulation purification total time t2 is different according to a different washing procedure range, and is preferentially 30 min to 60 min. A backwash time t3 is set to a range of 5 s to 15 s, and is preferentially 10 s.

A turbidity threshold in this embodiment of the present invention is set that:

A first turbidity threshold NTU1 is set to a range of 500 NTU to 600 NTU, and is preferentially 600 NTU;

A second turbidity threshold NTU2 is set to a range of above 900 NTU, and is preferentially 900 NTU; and

A third turbidity threshold NTU3 is set to a range of 50 NTU to 120 NTU, and is preferentially 80 NTU.

In the present invention, the foregoing turbidity interval and the corresponding drainage proportion n are not fixed, and is set according to a different machine type and/or washing procedure and/or load.

Based on explanation in the exemplary embodiments of the present invention, a washing machine with a circulation water purification and rinsing function may be a drum washing machine or may be an impeller washing machine. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A washing control method for circulative water-purification of a washing machine, wherein the washing machine comprises a water supply system, a drainage system, a circulation water purification apparatus and a turbidity detection apparatus, and wherein the circulation water purification apparatus is configured to perform circulation water purification and rinsing during a rinsing process, the method comprising:
detecting, by the turbidity detection apparatus, turbidity of washing water;
draining an amount of the washing water predetermined according the corresponding detected turbidity;
supplying clean water to reduce the turbidity; and
performing the circulation water purification and rinsing.

2. The washing control method according to claim 1, wherein the washing machine is provided with different turbidity ranges of the washing water, and wherein the method further comprises:
determining a corresponding turbidity range according to the detected turbidity of the washing water; and
setting different proportions of an amount of the washing water to be drained to a total amount of the washing water according to the different turbidity ranges.

3. The washing control method according to claim 1, wherein, after the amount of the washing water predetermined according the detected turbidity is drained, the step of supplying the clean water to reduce the turbidity comprises supplying the clean water until a set rinsing water level is reached.

4. The washing control method according to claim 1, wherein after washing is completed,
the turbidity detection apparatus detects the turbidity of the washing water; and
if the turbidity is less than a preset first turbidity threshold, the circulation water purification apparatus is directly turned on to perform circulation water purification; or
if the turbidity is greater than a preset second turbidity threshold, the washing water is completely drained, clean water is resupplied for rinsing, and at the same time, the circulation water purification is preformed; or
if the turbidity is within an interval of the preset first turbidity threshold and the preset second turbidity threshold, the amount of the washing water predetermined according the detected turbidity is drained, the remaining washing water is reserved, the clean water is supplied to reduce the turbidity, and the circulation water purification and rinsing is preformed.

5. The washing control method according to claim 1, wherein after washing is completed,
the turbidity detection apparatus detects the washing water turbidity; and
if the turbidity is less than a preset first turbidity threshold, the circulation water purification apparatus is directly turned on to perform circulation water purification; or
if the turbidity is greater than the preset first turbidity threshold, the amount of the washing water predetermined according the detected turbidity is drained, the clean water is supplied, and then the circulation water purification and rinsing is preformed.

6. The washing control method according to claim 1, wherein during a circulation water purification and rinsing process, turbidity of rinsing water is detected at a preset time interval, and if the rinsing water turbidity is less than a set third turbidity threshold, the rinsing is completed, the rinsing process stops, and the circulation water purification apparatus is turned off.

7. The washing control method according to claim 1, wherein during a circulation water purification and rinsing process, if a working time of the circulation water purification apparatus reaches a preset working time, the rinsing is completed, the rinsing process stops, and the circulation water purification apparatus is turned off.

8. The washing control method according to claim 1, wherein during a circulation water purification and rinsing process, if the rinsing reaches a preset time, it is detected whether rinsing water turbidity continuously increases within a preset time range, and if yes,
after water is completely or partially drained according to a change rate of the turbidity, clean water is supplied for rinsing; or if not, the circulation water purification and rinsing continues until the rinsing ends.

9. The washing control method for according to claim 1, further comprising:
setting proportions of an amount of the washing water to be drained to a total amount of the washing water according to the corresponding turbidities, wherein proportional values is greater than 0 and is less than 1, there is at least one proportional value, wherein a value of the proportional values and a quantity of the proportional values are related to a washing procedure.

10. A washing machine having the control method according to claim 1, comprising:
a water containing drum, a circulation water purification passage and a backwash passage,
wherein the circulation water purification passage comprises the water containing drum, a drainage system, a circulation water purification apparatus, a water supply system and a circulation passage of the water containing drum in order; and
wherein the backwash passage comprises a water supply system, a circulation water purification apparatus, and a drainage system passage.
